(19) United States
(12) Patent Application Publication
(10) Pub. No.: US 2025/0185807 A1
(43) Pub. Date: Jun. 12, 2025

(54) FLOATING HAND EASEL

(71) Applicant: Kris Niffenegger, Georgetown, TX (US)

(72) Inventor: Kris Niffenegger, Georgetown, TX (US)

(21) Appl. No.: 18/948,231

(22) Filed: Nov. 14, 2024

Related U.S. Application Data
(60) Provisional application No. 63/607,523, filed on Dec. 7, 2023.

(51) Int. Cl. A47B 97/04; F16M 11/04

(52) U.S. Cl. CPC A47B 97/04; F16M 11/045; F16M 11/048; A47B 2200/0092

(57) ABSTRACT

A desk apparatus includes a first member, a second member, and a third member. The first member includes first elongated slots. The second member includes second elongated slots. The second member includes first wheels that position in the first elongated slots. Further, the third member includes second wheels. The second wheels' position in the second elongated slots. The third member moves vertically along the second elongated slots with the help of the second wheels. The second member moves horizontally along the first elongated slots with the help of the first wheels. An object is placed over the first member. The desk apparatus allows the user to place his/her hand over the third member and move the second member and the third member to a desired position over the first member to perform a desired task on the object.

### CROSS-REFERENCE TO RELATED APPLICATIONS

The present application claims benefit of U.S. Provisional Application No. 63/607,523, filed Dec. 7, 2023; all of which is incorporated herein in its entirety and referenced thereto.

### BACKGROUND OF THE INVENTION

### Field of the Invention

The present invention relates to desks. More specifically, the present invention relates to a desk apparatus that allows a user to reach the entire area to perform a variety of tasks with ease.

### Description of the Prior Art

A desk is commonly used as a piece of furniture for performing a variety of tasks. Typically, the desk has a flat or an inclined surface upon which a user performs the tasks. An example of a task includes writing, studying or using objects by placing them over the flat or inclined surface. In some instances, the desk includes legs for supporting the desk at a height for the user to use at a comfortable position.

An exemplary desk is disclosed in a U.S. Pat. No. 4,538,861, entitled “Portable desk” (“the '861 patent”). The '861 patent discloses a portable desk having an exterior working or writing surface and internal compartments for storing writing or work-related items. The desk is useful in support of the activities of traveling business persons such as sales, engineering, and management personnel over and above such desk now known in the trade. The desk has a structure to hold important items required by traveling business persons in easily accessible compartments and in a manner such that the items cannot fall out or migrate between compartments when the desk is being carried or shipped. The desk has a two-section cover, the sections being respectively arranged to be pivoted upward to provide access to the whole of the interior or to a part of the interior.

Although the above discussed disclosures are useful, they still have problems and present incomplete solutions. For instance, the users having hand control issues find it difficult to perform certain tasks, say drawing or painting over the desk. This is because; they find it difficult to move their hands by lifting from one location and positioning at a different location to perform the draw or paint.

Therefore, there is a need in the art to provide an improved desk that allows the user to reach the entire area of the desk to perform a variety of tasks with ease.

### SUMMARY OF THE INVENTION

It is an object of the present invention to provide a desk apparatus that avoids the drawbacks of known desks.

It is another object of the present invention to provide a desk apparatus that allows the user to access the entire area of the desk with his hand without any discomfort.

In order to overcome one or more objects, the present invention presents a desk apparatus. The desk apparatus includes a first member, a second member, and a third member. The first member comes in a square or rectangular configuration and includes first elongated slots at both ends. The second member includes second elongated slots at both sides. The second member includes first wheels that position in the first elongated slots. Further, the third member includes second wheels at both sides. The second wheels' position in the second elongated slots. A user places an object on the first member. The object includes, but not limited to, an electronic device, a book, a writing pad, artwork, etc. The third member moves vertically along the second elongated slots of the second member with the help of the second wheels. The second member moves horizontally along the first elongated slots of the first member with the help of the first wheels. The desk apparatus allows the user to place his/her hand over the third member and move the second member and the third member to a desired position over the first member to perform a desired task on the object.

In one advantageous feature of the present invention, the user can place the object over the first member and place his hand over the third member to reach anywhere on the first member. The user can position his hands at a desired location over the first member by adjusting the position of the second member horizontally and the third member vertically.

Another advantageous feature of the present invention is that the user can place his hand on the third member and push up or down to move vertically and push side to side to move horizontally with the help of the second member in order to have a 360 degrees' access over the entire surface of the first member.

The features and advantages of the invention here will become more apparent in light of the following detailed description of selected embodiments, as illustrated in the accompanying FIGURES. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

FIG. 1 illustrates an environment in which a desk apparatus implements, in accordance with one embodiment of the present invention.

FIG. 2 illustrates a perspective view of the desk apparatus, in accordance with one embodiment of the present invention.

FIG. 3 illustrates a first member of the desk apparatus, in accordance with one embodiment of the present invention.

FIG. 4 illustrates a second member of the desk apparatus, in accordance with one embodiment of the present invention.

FIG. 5 illustrates a third member of the desk apparatus, in accordance with one embodiment of the present invention.

FIG. 6 illustrates the second member positioned over the first member, in accordance with one embodiment of the present invention.

FIG. 7 illustrates the third member positioned over the second member, which in turn is positioned over the first member, in accordance with one embodiment of the present invention.

FIG. 8 illustrates the second member positioned at one end of the first member, in accordance with one embodiment of the present invention.

FIG. 9 illustrates the second member positioned at center (substantially) of the first member, and the third member moved up over the second member, in accordance with one embodiment of the present invention.

### DETAILED DESCRIPTION OF THE PREFERRED EMBODIMENT

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed desk apparatus. However, it will be apparent to those skilled in the art that the presently disclosed invention may be practiced without these specific details. In some instances, well-known structures and devices are shown in functional or conceptual diagram form in order to avoid obscuring the concepts of the presently disclosed desk apparatus.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of a desk apparatus, it is to be further understood that numerous changes may arise in the details of the embodiments of the desk apparatus. It is contemplated that all such changes and additional embodiments are within the spirit and true scope of this disclosure.

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure.

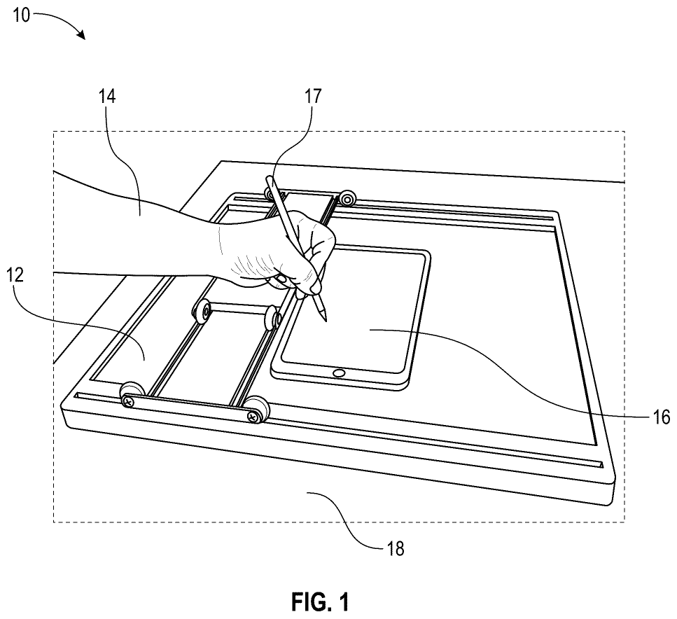

Various features and embodiments of a desk apparatus are explained in conjunction with the description of FIGS. 1-9.

FIG. 1 shows an environment 10 in which a desk apparatus 12 implements, in accordance with one embodiment of the present invention. Desk apparatus 12 is operated by a user 14 to place an object 16 and move his/her hand vertically and horizontally to perform a variety of tasks over object 16. An example of object 16 includes, but not limited to, an electronic device, a book, a writing pad, artwork, etc. The electronic device includes a tablet, mobile phone, watch, etc. In one example, user 16 holds a stylus 17 or any other component to operate object 16. User 14 places desk apparatus 12 on a surface 18 such as a table or floor. In one example, user 14 places object 16 say, a writing pad on desk apparatus 12 to write on it. In another example, user 14 places object 16 say, a tablet on desk apparatus 12 and operates it.

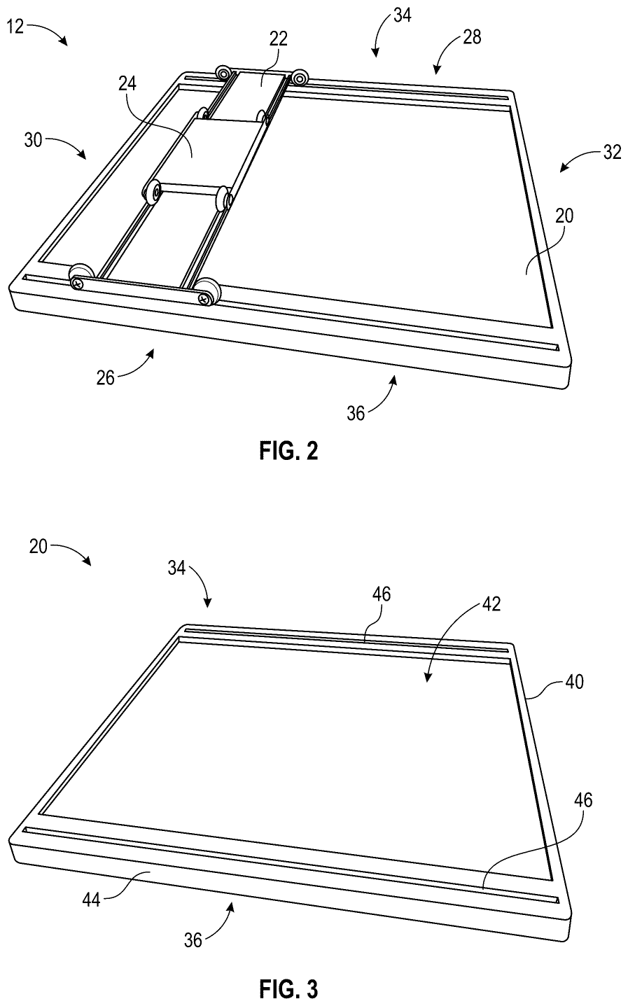

FIG. 2 shows a perspective view of desk apparatus 12, in accordance with one embodiment of the present invention. Desk apparatus 12 is made of metal, hard plastic, wood or combination thereof. In one example, desk apparatus 12 is made of a thermoplastic material using an injection molding process. Desk apparatus 12 includes a first structure 20, a second structure 22, and a third structure 24. Each of first structure 20, second structure 22, and third structure 24 presents a first end 26, a second end 28, a first side 30, a second side 32, a top end 34 and a bottom end 36. In one example, first end 26 indicates a front end and second end 28 indicates a rear end, or vice versa. Further, first side 30 indicates a right side and second side 32 indicates a right side, or vice versa.

FIG. 3 shows a perspective view of first structure 20, in accordance with one embodiment of the present invention. First structure 20 is made of a metal, hard plastic, wood or combination thereof. First structure 20 has a first member 40. First member 40 has a flat configuration with suitable thickness. First member 40 comes in a square or rectangular configuration. In some embodiments, first member 40 may come in any other shape depending on the need. First member 40 includes a storage area 42 formed by cutting a portion of first member 40 in a square or rectangular configuration at top end 34. Further, first member 40 includes a raised portion 44 at the edges. A person skilled in the art understands that raised portion 44 acts as a perimeter for storage area 42 and helps to retain object 16 in storage area 42. In one example, raised portion 44 includes first elongated slots 46. In one example, first elongated slots 46 are formed by chipping away a portion of raised portion 44. Here, first elongated slots 46 position at opposite ends of raised portion 44 i.e., at first end 26 and second end 28. As can be seen from FIG. 3, first elongated slots 46 extend substantially or the entire length of raised portion 44 at both first end 26 and second end 28.

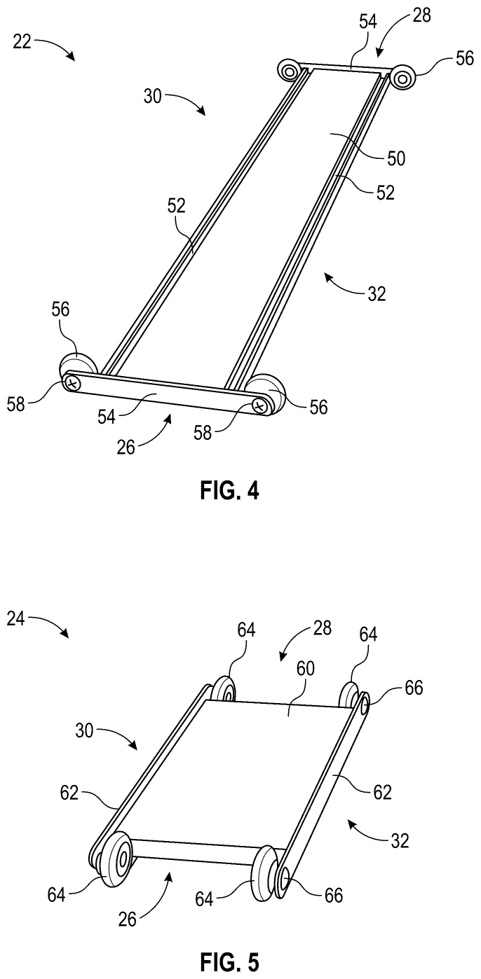

As specified above, desk apparatus 12 includes second structure 22. FIG. 4 shows a perspective view of second structure 22, in accordance with one embodiment of the present invention. Second structure 22 has a second member 50. Second member 50 has a flat configuration with suitable thickness. Second member 50 is made of metal, wood, hard plastic or any other suitable material. Second member 50 comes in a square or rectangular configuration. It is preferable to provide the length of second member 50 matching the distance between first elongated slots 46 positioned at opposite ends of raised portion 44 of first member 40. In one example, second member 50 comes in a rectangular configuration and matches the length of first member 40 from first end 26 to second end 28.

In accordance with one embodiment, second member 50 includes second elongated slots 52. Second elongated slots 52 are formed by chipping away a portion of second member 50. Here, second elongated slots 52 position at opposite sides of second member 50 say at first side 30 and second side 32. As can be seen from FIG. 4, second elongated slots 52 extend substantially or the entire length of second member 50 at both first side 30 and second side 32. Further, second member 50 includes first plate members 54, each mounted at first side 30 and second side 32. First plate member 54 is made of metal, wood, plastic or any other suitable material. Each first plate member 54 includes first wheels 56 at both distal ends. First wheels 56 are made of suitable material. First wheels 56 position in first elongated slots 46 and travel in horizontal direction i.e., from first side 30 to second side 32, or vice versa. In one example, first wheels 56 connect to first plate member 54 with the help of first connecting members 58. First connecting members 58 indicate fasteners or any other known connecting mechanisms.

Desk apparatus 12 includes third structure 24. FIG. 5 shows a perspective view of third structure 24, in accordance with one embodiment of the present invention. Third structure 24 includes a third member 60. Third member 60 has a flat configuration with suitable thickness. Third member 60 comes in a square or rectangular configuration. Third member 60 is made of metal, wood, hard plastic or any other suitable material. It is preferable to provide the width of third member 60 matching the distance between second elongated slots 52 positioned at opposite sides (first side 30 and second side 32) of second member 40. Further, the length of third member 60 is less than the length of second member 40. In one example, the length of third member 60 is half of the length of second member 40. Further, third member 60 includes second plate members 62, each mounted at first end 26 and second end 28. Second plate member 62 is made of metal, wood, plastic or any other suitable material. Each second plate member 62 includes second wheels 64 at both distal ends. Second wheels 64 are made of a suitable material. Second wheels 64 position in second elongated slots 52 and travel in a vertical direction i.e., from first end 26 to second end 28, or vice versa. In one example, second wheels 64 connect to second plate member 62 with the help of second connecting members 66. Second connecting members 66 indicate fasteners or any other known connecting mechanism.

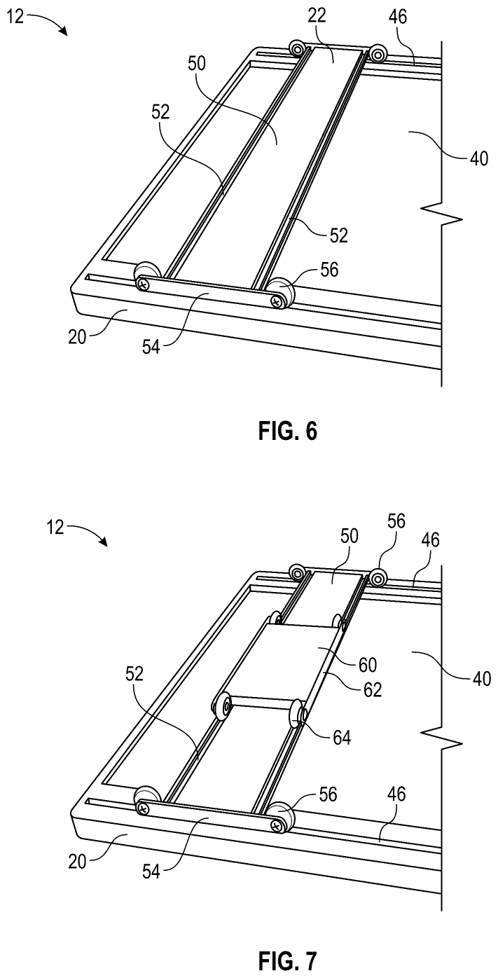

Now, referring to FIG. 6 and FIG. 7, assembly of desk apparatus 12 is explained, in accordance with one embodiment of the present invention. At first, first member 40 is placed on surface 18. Subsequently, second member 50 is positioned over first member 40. Here, second member 50 is aligned with first member 40 such that second member 50 is perpendicular to first elongated slots 46. Further, first wheels 56 is positioned in first elongated slots 46, as shown in FIG. 6. Subsequently, third member 60 is positioned over second member 50. Here, third member 60 is aligned parallel to second member 50. Further, second wheels 64 are positioned in second elongated slots 52, as shown in FIG. 7. A person skilled in the art understands that first member 40 acts as a base member, second member 50 acts as a middle member and third member 60 acts as a top member.

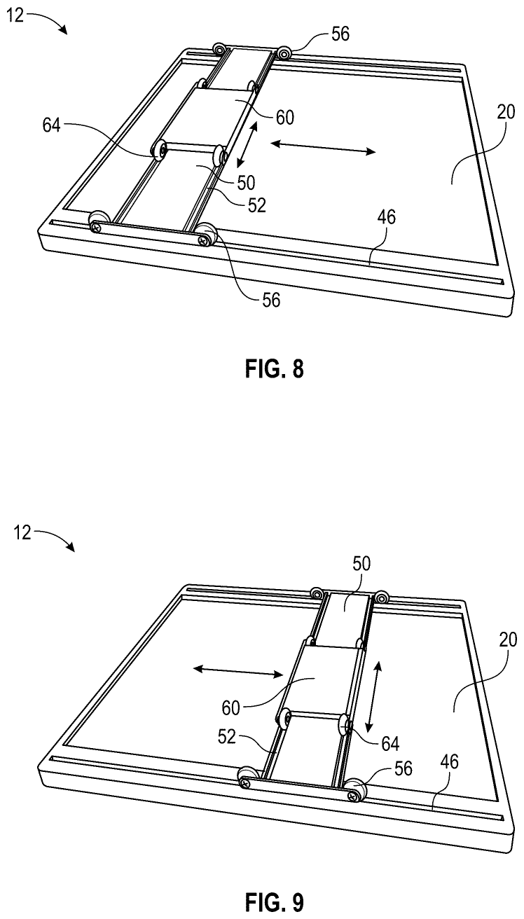

As can be seen from FIG. 7, first wheels 56 position in first elongated slots 46 and second wheels 64 position in second elongated slots 52. In accordance with present invention, first wheels 56 are configured to travel along first elongated slots 46 in a horizontal direction i.e., from first side 30 to second side 32, or vice versa. FIG. 8 shows the feature of second member 50 positioned closer to first side 30. Here, first wheels 56 travel along first elongated slots 46 to move horizontally. Furthermore, second wheels 64 are configured to travel along second elongated slots 52 in a vertical direction i.e., from first end 26 to second end 28, or vice versa. FIG. 9 shows the feature of second member 40 positioned substantially at the center of first member 40 and third member 50 positioned closer to first end 26 indicating the third member 50 moved up vertically from the position shown in FIG. 8.

In use, user 14 places object 16 over first member 40 i.e., at storage area 42, as shown in FIG. 1. Consider that object 16 is a writing pad/painting. Here, user 14 places his/her hand over third member 60. In order to move vertically, user 14 pushes up or down such that third member 60 moves vertically along second elongated slots 52 of second member 50. Further, user 14 pushes his/hand from one side to another (say left to right, or vice versa) such that second member 50 moves horizontally along first elongated slots 46 of first member 50. In one example, user 14 moves hand at an angle such that both third member 60 and second member 50 move simultaneously to reach a desired location on storage area 42 for performing the task of painting. A person skilled in the art understands by selectively adjusting both vertical position and horizontal position with the help of third member 60 and second member 50, respectively, user 14 has the ability to reach the entire area of storage area 42. The ability to reach the entire area of first member 40 with little effort allows users with hand control issues to perform tasks by placing object 16 over first member 40 easily without putting much effort. In addition, desk apparatus 12 supports the hand as well as steadying it for those with muscle control issues. Further, user 14 is able to place his/her hand over third member 60 and as a result, user's hand is kept away from object 16 thereby preventing any accident smudges on object 16.

The presently disclosed apparatus provides several advantages over the prior art. The desk apparatus allows the user to place the object over the first member and place his hand over the third member to reach anywhere on the first member. In other words, the desk apparatus allows the user to place his hand on the third member and push up or down to move vertically and push side to side to move horizontally with the help of the second member in order to have a 360 degrees' access over the entire surface of the first member.

Applicant or inventor of the present invention intend to market the system as “The Floating Hand Writing Desk” or any other suitable names.

A person skilled in the art appreciates that the apparatus can come in a variety of shapes and sizes depending on the need and comfort of the user. Further, many changes in the design and placement of components may take place without deviating from the scope of the presently disclosed desk apparatus.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A desk apparatus, comprising:
a first member having first elongated slots extending along its width;
a second member movably mounted on said first member, and wherein said second member comprises second elongated slots; and
a third member movably mounted on said second member,
wherein said second member moves horizontally along said first elongated slots,
wherein said third member moves vertically along said second elongated slots, and
wherein said second member and said third member enable a user to access various positions on said first member.

2. The desk apparatus of claim 1, wherein said first member comprises a storage area receiving an object to be accessed by said user, and wherein said first elongated slots position at opposite ends of said storage area.

3. The desk apparatus of claim 2, wherein said second member comprises first wheels, and wherein said first wheels position in said first elongated slots and configure to move horizontally along said first elongated slots.

4. The desk apparatus of claim 3, wherein said third member comprises second wheels, and wherein second first wheels position in said second elongated slots and configure to move vertically along said second elongated slots with respect to said first elongated slots.

5. The desk apparatus of claim 2, wherein said first member comprises a raised portion around said storage area to secure an object within said storage area.

6. The desk apparatus of claim 5, wherein said first elongated slots position at said raised portion.

7. The desk apparatus of claim 2, wherein said storage area is formed by cutting a portion of said first member.

8. The desk apparatus of claim 1, wherein said third member configures to support a hand of said user to control the movement of said third member and said second member without contacting said object placed on said first member.

9. The desk apparatus of claim 1, wherein said second member is longer than said third member.

10. A desk apparatus, comprising:
a first member comprising a storage area and first elongated slots, wherein said first elongated slots are positioned at opposite ends of said storage area;
a second member comprising second elongated slots at the top and first wheels at the bottom, wherein said second elongated slots position at opposite ends, and wherein said second elongated slots are perpendicularly to said first elongated slots of said first member; and
a third member comprising second wheels at the bottom,
wherein said first wheels position in said first elongated slots and configure to move horizontally along said first elongated slots,
wherein said second wheels position in said second elongated slots such that said third member mounts on top of said second member and configure to move said third member along said second elongated slots vertically, and
wherein said second member and said third member enable a user to access various positions on said storage area.

11. The desk apparatus of claim 10, wherein said first member comprises a raised portion positioned around said storage area to secure an object within said storage area.

12. The desk apparatus of claim 11, wherein said first elongated slots position at said raised portion.

13. The desk apparatus of claim 10, wherein said storage area is formed by cutting a portion of said first member.

14. The desk apparatus of claim 10, wherein said third member configures to support a user's hand to control the movement of said third member and said second member without contacting an object placed on said first member.

15. The desk apparatus of claim 10, wherein said second member is longer than said third member.

16. A method of providing a desk apparatus, said method comprising the steps of:
providing a first member having first elongated slots extending along its width;
providing a second member movably mounted on said first member, said second member comprising second elongated slots;
providing a third member movably mounted on said second member; and
operating said second member to move horizontally along said first elongated slots, and said third member to move vertically along said second elongated slots for enabling a user to access various positions on said first member.

17. The method of claim 16, further comprising:
providing a storage area at said first member; and
providing a raised portion positioned around said storage area to secure an object within said storage area.

18. The method of claim 17, further comprising enabling said user to place a hand on said third member for simultaneous vertical and horizontal movement of said third member and said second member to access various positions on said first member.

19. The method of claim 16, further comprising providing first wheels at said second member, said first wheels positioning in said first elongated slots to move said second member horizontally along said first elongated slots.

20. The method of claim 19, further comprising providing second wheels at said third member, said second wheels positioning in said second elongated slots to move said third member vertically along said second elongated slots.
